(19) United States
(12) Patent Application Publication
(10) Pub. No.: US 2011/0000069 A1
(43) Pub. Date: Jan. 6, 2011

(54) PROCESS FOR MOUNTING A VALVE IN A REFRIGERATION COMPRESSOR

(75) Inventors: Roberto Ramsdorf, Joinville - SC (BR); Guilherme Alan Kruger, Joinville - SC (BR)

Correspondence Address: GIFFORD, KRASS, SPRINKLE,ANDERSON & CITKOWSKI, P.C, PO BOX 7021, TROY, MI, 48007-7021, US

(73) Assignee: WHIRLPOOL S.A., Sao Paulo -Sp (BR)

(21) Appl. No.: 12/843,297

(22) Filed: Jul. 26, 2010

Related U.S. Application Data
(63) Continuation-in-part of application No. 12/094,234, filed on Jul. 7, 2008.

(51) Int. Cl. B23P 19/04

(52) U.S. Cl. 29/428

(57) ABSTRACT

A process for mounting a valve in a refrigeration compressor which presents a compression chamber (3) closed by a valve plate (4, 20) having suction and discharge orifices (5, 21; 6, 22), each being selectively closed by a respective valve element (10) having a mounting end portion (11) attached to an adjacent face of the valve plate (4, 20); a receiving recess (23) provided in the valve plate (20) to house said mounting end portion (11); and a first retaining means (8, 9) to be seated and secured against said adjacent face of the valve plate (20). The process comprises the steps of: providing a orientation projection (40) to be fitted into a respective orientation recess (30) provided in at least one of the parts of receiving recess (23) of the valve plate (20) and mounting end portion (11) of the valve element (10); providing a second retaining means (50) between the receiving recess (23) and said mounting end portion (11), the second retaining means (50) being a liquid presenting a surface tension sufficient to maintain said mounting end portion (11) retained in the respective receiving recess (23) of the valve plate (20), upon mounting the valve; mounting the valve element (10) on the valve plate (20), fitting the mounting end portion (11) of the valve element (10) inside the receiving recess (23) and the orientation projection (40) into the orientation recess (30); and fixing the first retaining means retaining the valve element (10) in its position in the valve plate (20).

### CROSS-REFERENCE TO RELATED APPLICATION

This application is a continuation-in-part of U.S. patent application Ser. No. 12/094,234 filed Jul. 7, 2008, claiming priority of PCT/BR2006/00281 filed Dec. 18, 2006.

### FIELD OF THE INVENTION

The present invention refers to a process for mounting a valve, which is not of the single piece type, in a refrigeration compressor, such as that used in small refrigeration systems.

### BACKGROUND OF THE INVENTION

The energetic efficiency of the refrigeration compressors is mostly attributed to the good performance of their valves in the control of the gas flow.

In the reciprocating refrigeration compressors, the compression of the refrigerant gas is achieved by movement of the piston, which is driven by a driving means, such as a mechanism of the connecting rod—crankshaft type, or by a linear motor. The piston reciprocates inside the compression chamber and, at the moment it begins to return from the upper dead point to the lower dead point, in its suction stroke, it draws the refrigerant gas from the suction line of the refrigeration system to which the compressor is coupled (that is, coming from the evaporator of the refrigeration system). Subsequently, when said piston returns from the lower dead point, in its compression stroke, it compresses the refrigerant gas which, under high pressure (of condensation), flows through the discharge system and returns to the refrigeration system to which the compressor is coupled.

Reciprocating refrigeration compressors use one way valves to control the gas flow during operation thereof. The valve systems contained in the head are responsible for regulating the flow rate and optimizing the dynamics of the gas flow during the suction and discharge of refrigerant gas in relation to the compression cylinder. A suction valve controls the gas flow coming from the suction line connected to the low pressure side of the refrigeration system and which is drawn into the interior of the compression cylinder, while a discharge valve controls the already compressed gas flow to be directed to the high pressure side of the refrigeration system.

The suction valve is designed to be responsible not only for regulating the gas flow during the suction, but also in order that its opening and closing pendular movement be synchronized with the displacement of the piston. Actually, for a better performance in the compression cycle, it is desired to anticipate the opening of the suction valve (in relation to the arrival of the piston at the upper dead point), in order to increase the volumetric efficiency.

The suction and discharge valves generally comprise one or more passage orifices and vanes that are fixed by one of the ends thereof, so that, when a pressure differential is established through the valve, the vane moves, allowing the passage of gas in the required preferential direction.

There are countless embodiments of suction valve systems adopted in reciprocating compressors, regarding the project of the obturator, of the valve seat, of the gas passage orifice and also the way the valve is attached.

In the construction in which the suction valve is of the single-piece type, made of a laminar plate to be mounted to the valve plate, the suction valve is usually dimensioned to have its lateral movement restricted by head screws (FIG. 1), which attach the single-piece suction valve to both the valve plate and the head. This construction minimizes possible lateral and transverse movements, which may alter the positioning of the suction valve when mounted to the valve plate. In spite of this advantage, said construction presents a high cost due to the raw material that is consumed in the production of said suction valve. Furthermore, such construction requires additional machining operations of the faces of the blank valve plate.

In a known prior art arrangement for mounting a single-piece suction valve, the latter is substituted by a valve that is not constructed in a single-piece, or valve element, which is lodged in a recess produced in the valve plate (FIG. 2), the procedure for the fixation of said valve element to the valve plate being achieved by mechanically interlocking said parts, generally by riveting or spot welding.

Nevertheless, although not presenting the constructive deficiencies of the single-piece suction valve, said solution has the disadvantage of requiring an additional process for mounting the valve plate assembly, which is required to guarantee the correct positioning of the valve element in the recess.

In the known process disclosed in U.S. Pat. No. 7,390,176, the valve is retained to the valve plate by a screw or a similar permanent retaining means, in order to keep the desired positioning of the valve in relation to the valve plate, not only during the mounting of the cylinder cover against the valve plate, but during the operational life of the compressor.

Said mounting process requires the provision of additional parts or elements for defining the permanent retaining means in the valve arrangement and additional steps to provide holes for receiving said retaining means.

In another known process (U.S. Pat. No. 5,887,622) the position of the valve element in relation to the valve plate is guaranteed by a complex arrangement in which an additional permanent retaining element is mounted into a cavity on the valve plate in the region of the valve, in order to constantly force the fixing portion of the valve element against the valve plate. Although this construction does not require the provision of holes in the valve, its formation is complex, requiring a plurality of elements and a more precise construction of pieces, in order to allow a correct mounting of the valve.

### OBJECTS OF THE INVENTION

Thus, it is an object of the present invention to provide a process for mounting a valve in a refrigeration compressor, which reduces the number of parts and the mounting steps of the valve element on the valve plate, and which leads to a correct positioning of the valve element in the valve plate, until the final mounting of the cylinder cover against the valve plate.

Another object of the present invention is to provide a process for mounting a valve in a refrigeration compressor, as mentioned above and which is less complex and more reliable than the known mounting processes.

An additional object is to provide a valve mounting process as cited above, which leads to a reduced cost.

### SUMMARY OF THE INVENTION

These and other objects are achieved through a process for mounting a valve in a compressor of the type that presents a cylinder defining, in its interior, a compression chamber having an end closed by a valve plate provided with at least one suction orifice and at least one discharge orifice, each being selectively closed by a respective valve element having a mounting end portion attached to an adjacent face of the valve plate; a bending median portion; and a sealing end portion operatively associated with the respective orifice on the valve plate; a receiving recess provided in the valve plate to house the mounting end portion of the valve element; a first retaining means to be seated and secured against said adjacent face of the valve plate, in order to retain the mounting end portion of the valve element in the interior of the receiving recess, the process being.

The process of mounting the valve comprises the steps of:
providing at least one orientation recess in at least one of the parts of receiving recess of the valve plate and mounting end portion of the valve element and a respective orientation projection to be fitted into a respective orientation recess;
providing a second retaining means between the receiving recess and the mounting end portion of the valve element, so as to avoid the latter from moving outwardly from the receiving recess before mounting the first retaining means, said second retaining means being a liquid presenting a surface tension sufficient to maintain the mounting end portion of the valve element retained in the respective receiving recess of the valve plate, upon mounting the valve;
mounting the valve element on the valve plate, fitting the mounting end portion of the valve element inside the receiving recess and the orientation projection into the orientation recess; and
fixing the first fixing elements retaining the valve element in its position in the valve plate.

### BRIEF DESCRIPTION OF THE DRAWINGS

The invention will be described below with reference to the enclosed drawings, given by way of example of one embodiment of the invention and in which:

FIGS. 1 and 1a schematically and respectively represent a plan view of a valve plate, when observed from the side of the compression cylinder and illustrating a suction orifice and a single-piece suction valve, said valve plate and suction valve being constructed according to the prior art;

FIG. 2 schematically represents a perspective view of a valve plate and valve element constructed according to another prior art embodiment;

FIGS. 3 and 3a schematically and respectively represent an exploded perspective view of a valve plate, when observed from the side of the compression cylinder and illustrating a suction orifice, a discharge orifice and a valve element, and a suction valve not of the single-piece type, said valve plate and valve element being constructed according to the present invention;

FIG. 4 schematically represents an enlarged sectional view of the region in which the valve plate is mounted between a top cylinder portion and a head, for the valve plate—valve element construction illustrated in FIG. 3, the mounting end portion of said valve element being seated on the valve plate; and

FIG. 5 represents an enlarged view of the region in which the end portion is mounted in the receiving recess of the valve plate.

### DETAILED DESCRIPTION OF THE INVENTION

The present invention will be described in relation to a refrigeration compressor comprising, in the interior of a casing (not illustrated), a motor-compressor assembly including a cylinder 1 that lodges a piston 2 reciprocating within a compression chamber 3 defined in the interior of said cylinder 1 between a top portion of said piston 2 and a valve plate 4 seated onto an end portion of the cylinder 1, said prior art valve plate 4 being described below.

The compressor further carries an electric motor (not illustrated) that drives said piston 2 in suction and compression strokes of a refrigerant gas of a refrigeration system to which the compressor is coupled, said refrigerant gas being admitted in the interior of the compression chamber 3, from a suction line of the refrigeration system to which the compressor is coupled.

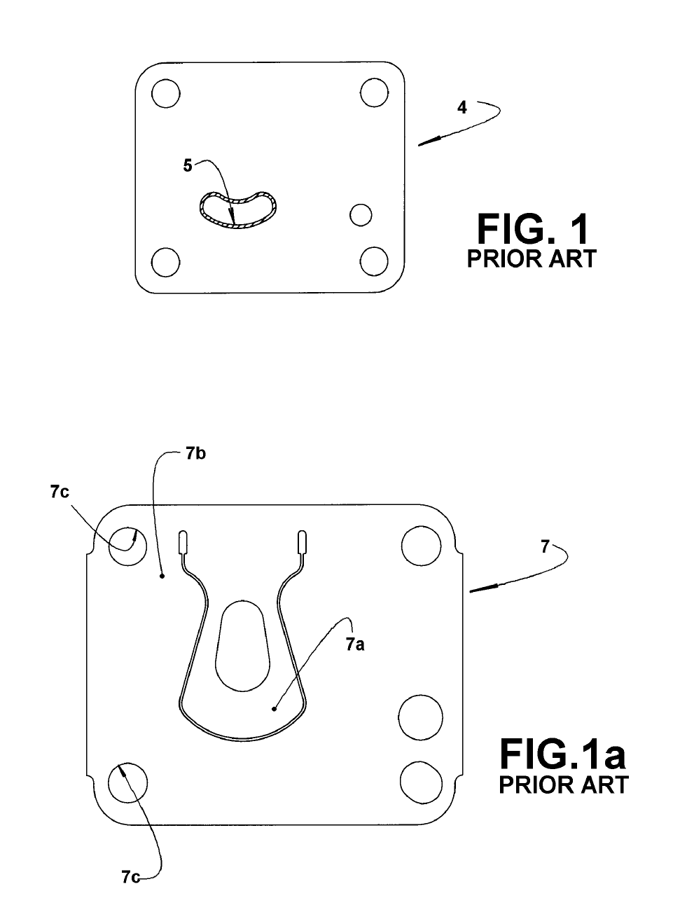

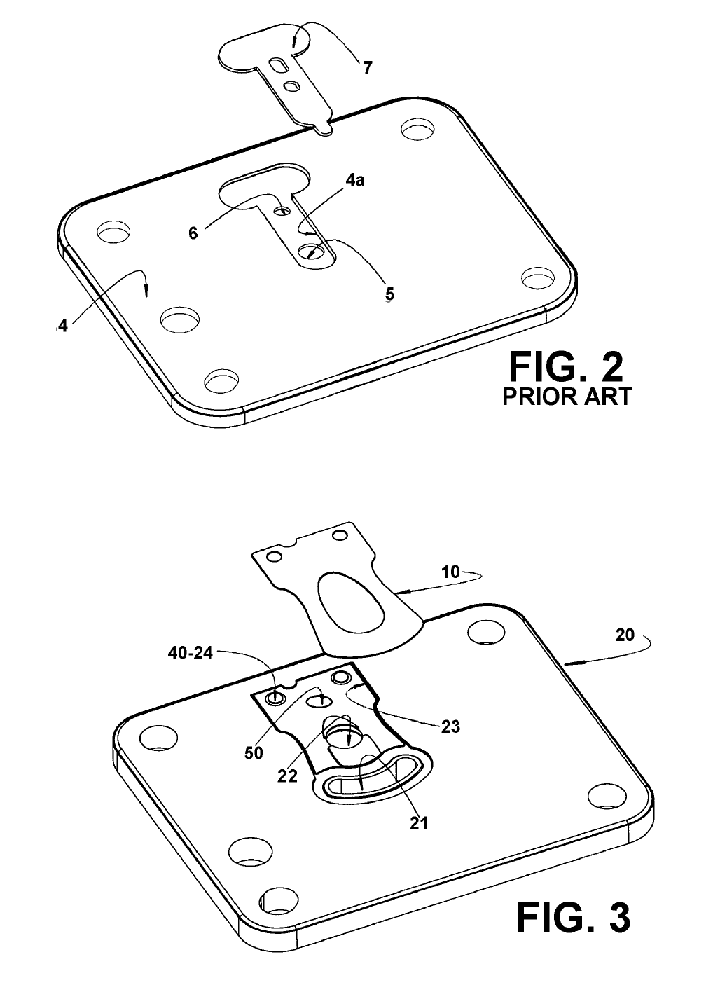

The prior art valve plate 4 illustrated in FIGS. 1, 1a and 2 is provided with at least one suction orifice 5 and with at least one discharge orifice 6, each being selectively closed by a respective suction valve 7 and a discharge valve (not illustrated) carried by the valve plate 4.

In the prior art construction illustrated in FIGS. 1 and 1a, the suction valve 7 is of the type that comprises a flexible vane 7a, stamped in a support blade 7b made of a material having adequate characteristics to the operation of the flexible vane 7a during the opening and closing of the suction orifice 5 and which is attached between a valve plate 4 and a cylinder cover 8, by appropriate means (not illustrated). The support blade 7b is provided with holes 7c, which receive fixation means (not illustrated) for retaining said support blade 7b between the cylinder cover 8 and the valve plate 4. The cylinder cover 8 is attached to the valve plate 4, so as to separate the high and low pressures sides and internally define at least one suction chamber (not illustrated) maintained in selective fluid communication with the compression chamber 3 through the suction orifice 5.

In the prior art construction illustrated in FIG. 2, the suction valve 7 is in form of a valve element welded to a recess 4a produced on the valve plate 4, with a contour similar and external to the contour of the suction valve 7 mounted in said recess 4a.

These prior art constructions present the deficiencies already mentioned above.

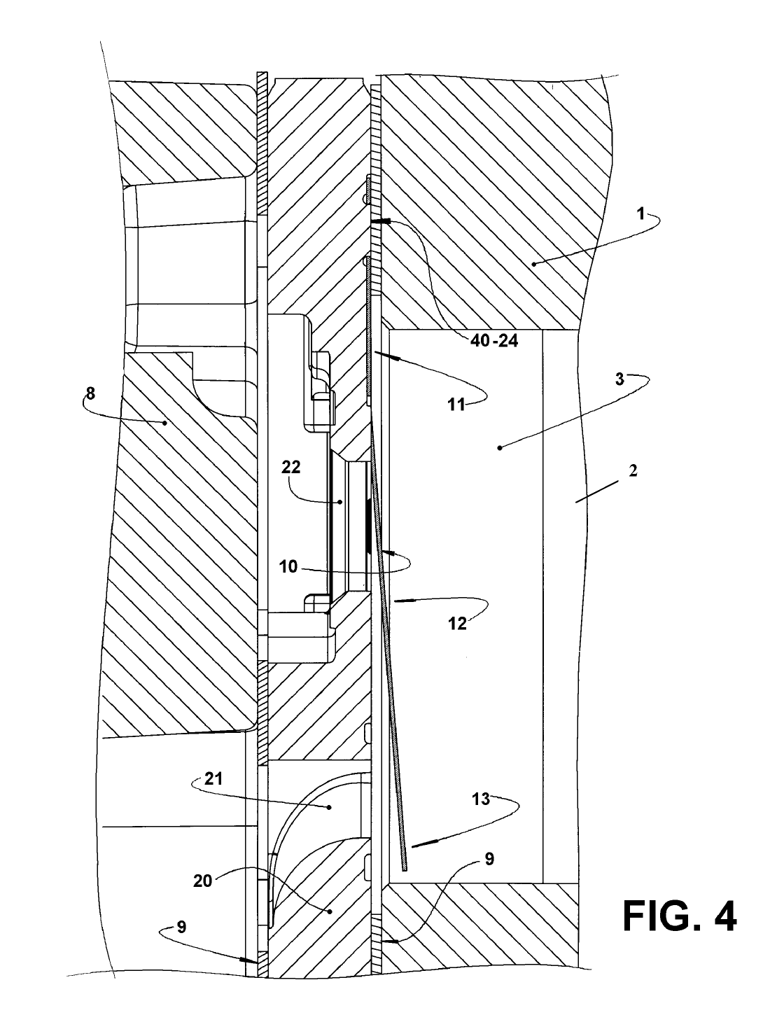

As mentioned above and illustrated in the enclosed drawings, the invention refers to a valve mounting process in a refrigeration compressor of the above-mentioned type and which it comprises at least one valve element 10 (FIG. 4) having a mounting end portion 11 attached to an adjacent face of a valve plate 20 of the present invention and described below; a bending median portion 12; and a sealing end portion 13, operatively associated with the respective orifice on the valve plate 20 and which in the illustrated construction is a suction orifice 21, and the valve element 10 is a suction valve.

In the construction of the illustrated valve element 10, the bending median portion 12 comprises a median opening 14 aligned with a discharge orifice 22 defined on the valve plate 20 and imparts to the valve element 10, in both its bending median portion 12 and sealing end portion 13, a U-shape with the legs united by the mounting end portion 11.

The valve element 10 presents a determined geometry defined in such a way as to result in a vane with an optimum ratio between stiffness and maximum bending stress, as described ahead.

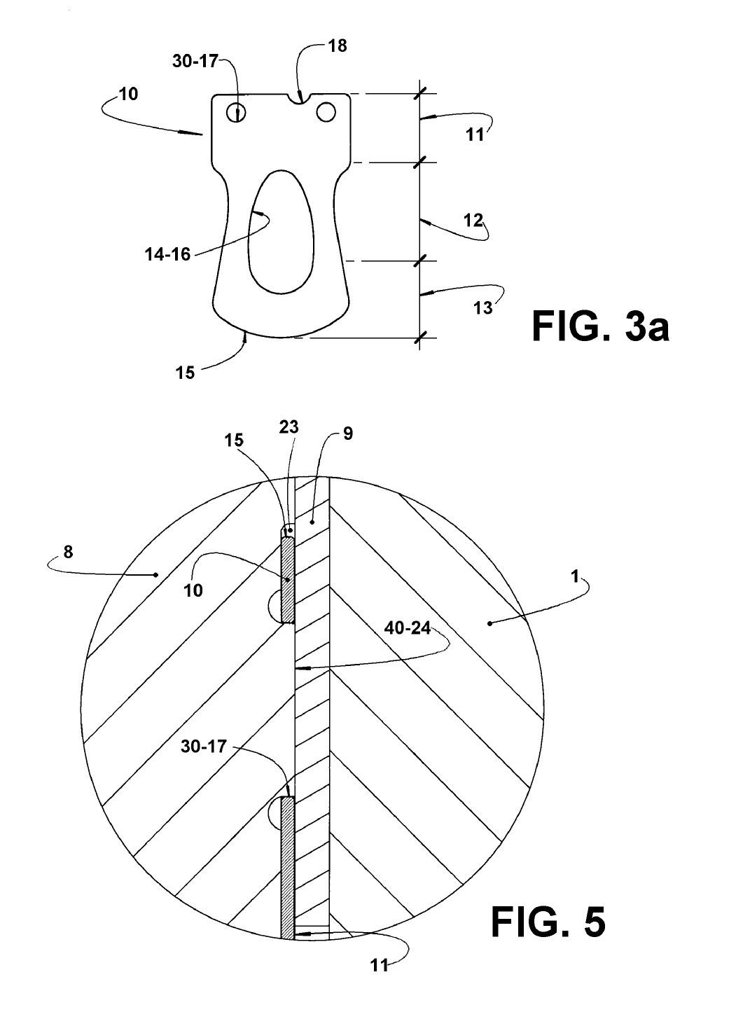

The valve element 10 is defined in a sheet made of flexible material with a reduced thickness comprising an outer edge 15 (FIG. 3a), defining the external contour of said valve element 10, for example, substantially U-shaped, and an inner edge 16 defining the contour of the median opening 14.

As best seen in FIG. 4, the valve plate 20 is provided with at least one suction orifice 21 and at least one discharge orifice 22, said valve plate 20 being further provided with a receiving recess 23 for housing and lodging the mounting end portion 11 of the valve element 10, said receiving recess 23 presenting a contour similar to and surrounding the contour of said mounting end portion 11, so that the latter is tightly disposed in said receiving recess 23, avoiding lateral movements of said mounting end portion 11 in the interior of the receiving recess 23. With this construction, the mounting end portion 11 is retained, by interference, in the interior of the receiving recess 23, against lateral displacements in a mutual seating plane of said parts of mounting end portion 11 and receiving recess 23.

The valve plate 20 should be obtained, for example, by sintering, stamping or machining, the latter being the most expensive.

In a particular form as illustrated in the enclosed figures, the receiving recess 23 presents a contour corresponding to that of the respective valve element 10 along the whole periphery thereof, said contour of the receiving recess 23 maintaining a minimum clearance from the adjacent contour of the valve element 10, in the parts of bending median portion 12 and sealing end portion 13 of said valve element 10, so as not to interfere with the closing and opening operations of these portions of the valve element 10.

The valve mounting arrangement being described further comprises at least one orientation recess 30 provided in at least one of the parts of receiving recess 23 of the valve plate 20 and mounting end portion 11 of the valve element 10, and at least one orientation projection 40, carried by at least one of the parts of receiving recess 23 of the valve plate 10 and mounting end portion 11 of the valve element 10, and to be fitted in the orientation recess 30 provided in the other part, in order to avoid relative displacements between the valve element 10 and the valve plate 20 in the seating plane of said parts.

Within the concept presented herein, it is possible to make different constructions of orientation recess and orientation projection, such as, respectively, grooves or through holes and saliences or pins projecting from the part where they are provided. Other solutions are also possible, in which there is the provision of at least one projection and one recess in each of the parts of receiving recess 23 of the valve plate 20 and mounting end portion 11 of the valve element 10.

In the illustrated constructions, the valve element 10 comprises two orientation recesses 30 in the form of holes 17, for example through holes, which are symmetrically provided in the longitudinal axis of the valve element 10, each being fitted in a respective orientation projection 40 defined in the receiving recess 23 of the valve plate 20, in the form of a pin 24 incorporated in a single piece to the valve plate 20, projecting from the bottom face of the receiving recess 23.

Independent of the constructive form of each orientation projection 40, this must have a height calculated to be at maximum equal to that of the face of the valve plate 20, in which is defined the receiving recess 23 carrying said orientation projection 40, in order not to interfere with the mounting of the valve plate 10 between the cylinder and the cylinder cover 8.

In the present invention, the fixation of the parts being mounted is achieved by a first retaining means to be seated and secured against an adjacent face of the valve plate 20 carrying the valve elements 10, in order to retain the mounting end portion 11 of said valve elements 10 in the interior of the receiving recess 23 and by the orientation projection 40 being fitted in the respective orientation recess 30.

In the case the valve element 10 defines a discharge valve, said first retaining means is defined by the cylinder cover 8, which is seated and secured onto the valve plate 20, attaching the latter to the cylinder block through adequate means. In some constructions, this mounting arrangement further presents at least one sealing gasket 9 (FIG. 4) between the parts of cylinder cover 8 and valve plate 20 and between the latter and the cylinder 1.

In the case the valve element 10 defines a suction valve, said first retaining means is defined by a top portion of the cylinder 1. In this case, it is also necessary to provide the present mounting arrangement with a second retaining means 50 (FIG. 3) provided between the receiving recess 23 and the mounting end portion 11 of the valve element 10, so as to avoid the latter from moving outwardly from the receiving recess 23 of the valve plate 10, before mounting the first retaining means.

It should be understood that the provision of the second retaining means 50 may be also applied to the mounting end portion of the discharge valve element, in cases in which said second retaining means 50 is also useful for providing a preliminary retention of the discharge valve element to the valve plate, during the mounting process of the compressor.

In a way of carrying out the present invention, the second retaining means 50 is a liquid presenting enough surface tension to maintain the mounting end portion 11 of the valve element 10 retained in the respective receiving recess 21 of the valve plate 20 upon mounting the valve. Said liquid can be, for example, a viscous liquid, such as oil, and more particularly, a lubricant oil of the type used in refrigeration compressors.

In another constructive form of the present invention, the second retaining means 50 is an adhesive that maintains the mounting end portion 11 of the valve element 10 retained in the respective receiving recess 23.

According to the present invention, the process for mounting a valve in a refrigeration compressor of the type above described generically comprises the steps of:
providing at least one orientation recess 30 in at least one of the parts of receiving recess 23 of the valve plate 20 and mounting end portion 11 of the valve element 10 and a respective orientation projection 40 to be fitted into a respective orientation recess 30;
providing a second retaining means 50 between the receiving recess 23 and the mounting end portion 11 of the valve element 10, so as to avoid the latter from moving outwardly from the receiving recess 23 before mounting the first retaining means, said second retaining means 50 being a liquid presenting a surface tension sufficient to maintain the mounting end portion 11 of the valve element 10 retained in the respective receiving recess 23 of the valve plate 20, upon mounting the valve;
mounting the valve element 10 on the valve plate 20, fitting the mounting end portion 11 of the valve element 10 inside the receiving recess 23 and the orientation projection 40 into a respective orientation recess 30; and
seating and securing the first retaining means 8, 9 against the adjacent face of the valve plate 20, in order to fix the valve element 10 in its operational position in the valve plate 20.

According to the present invention, the second retaining means 50 is provided to operate for retaining the valve element 10 into the receiving recess 23 against orthogonal displacements that permit the valve element 10 to come out from the receiving recess 23, at least temporarily, upon mounting said parts to the cylinder 1.

In order to facilitate the correct mounting of the valve element 10 to the valve plate 20, said valve element 10 comprises an eccentric indexing means 18 provided in its mounting end portion 11, particularly adjacent to an edge of said mounting end portion 11.

The fixation of the valve in the housing is achieved through the joint action of at least two of the following three factors: the actuation of the orientation projections 40 in the orientation recesses 30, positioning the valve element 10 on the valve plate 20 and restricting the lateral and longitudinal movements of said valve element 10 in relation to the receiving recess 23; the profile of the mounting end portion 11 of the valve element 10 and the corresponding profile of the adjacent contour of the receiving recess 23, said profiles helping to restrict the lateral and longitudinal movements of said valve element 10; and the application of the second retaining means 50, in the form of an oil or adhesive, which is dosed and applied to the region of the mounting end portion 11, for example, close to the orientation projections 40, adhering the valve element 10 inside the receiving recess 23 and hindering said valve element 10 from moving away from said receiving recess 23.

According to the concept of the invention disclosed herein, the present mounting process guarantees the fixation of the valve element 10 to the receiving recess 23, at least until mounting the first retaining means, by action of at least two of the parts of: orientation projection 40 and respective orientation recess 30; second retaining means 50 and receiving recess 23, presenting a contour similar to and surrounding the contour of the mounting end portion 11, so that to place the latter in said receiving recess 23.

In the construction in which the receiving recess 23 does not have a contour similar to and surrounding the contour of the mounting end portion 11, so that the latter is tightly disposed in said receiving recess 23, the fixation of the valve element 10 to the receiving recess 23 is guaranteed, at least until the first retaining means is mounted, by action of each orientation projection 40 and respective orientation recess 30, and also of the second retaining means 50.

In the condition in which the receiving recess 23 presents a contour similar to and surrounding the contour of the mounting end portion 11, so that the latter is tightly disposed in said receiving recess 23, the fixation of the valve element 10 to the receiving recess 23, at least until mounting the first retaining means, is guaranteed with the provision of one or both of the parts of orientation projection 40 and respective orientation recess 30, and also of the second retaining means 50.

The mounting of a valve element 10 housed in a receiving recess 23 defined in the valve plate 20 results in a cost reduction as compared to the known prior art mounting arrangements, since it consumes less quantity of raw material for producing the valve element 10 and dispenses additional machining operations of the faces of the blank valve plate 20. Moreover, the described valve mounting method simplifies the process of defining the receiving recess 23 in the valve plate 20, which is achieved during the sintering thereof, as well as the process for affixing the valve element 10 in the receiving recess 23, and eliminates the need of a fixation step, by welding the valve element 10, when this is a suction valve, to the valve plate 10. The provision of an eccentric indexing means 18 in the valve element 10 allows the latter to be correctly mounted to the valve plate 20, considering the lamination and pre-tension of the valve.

While only one possible embodiment for the mounting arrangement of the invention has been illustrated herein, it should be understood that this is exemplary, not intended to limit the inventive scope defined in the claims accompanying the present specification.

1. A process for mounting a valve in a refrigeration compressor of the type that presents a cylinder (1) defining, in its interior, a compression chamber (3) having an end closed by a valve plate (4, 20) provided with at least one suction orifice (5, 21) and at least one discharge orifice (6, 22), each being selectively closed by a respective valve element (10) having a mounting end portion (11) attached to an adjacent face of the valve plate (4, 20), a bending median portion (12), and a sealing end portion (14) operatively associated with the respective orifice on the valve plate (4, 20); a receiving recess (23) provided in the valve plate (20) to house the mounting end portion (11) of the valve element (10); a first retaining means (8, 9) to be seated and secured against said adjacent face of the valve plate (20), in order to retain the mounting end portion (11) of the valve element in the interior of the receiving recess (23), the process being characterized in that it comprises the steps of:
providing in at least one of the parts of the receiving recess (23) of the valve plate (20) and mounting end portion (11) of the valve element (10), at least one orientation projection (40) to be fitted into a respective orientation recess (30) provided in the other of said parts;
providing a second retaining means (50) between the receiving recess (23) and the mounting end portion (11) of the valve element (10), so as to avoid the latter from moving outwardly from the receiving recess (23) before mounting the first retaining means, said second retaining means (50) being a liquid presenting a surface tension sufficient to maintain the mounting end portion (11) of the valve element (10) retained in the respective receiving recess (23) of the valve plate (20), upon mounting the valve;
mounting the valve element (10) on the valve plate (20), fitting the mounting end portion (11) of the valve element (10) inside the receiving recess (23) and the orientation projection (40) into a respective orientation recess (30); and
seating and securing the first retaining means (8, 9) against the adjacent face of the valve plate (20), in order to fix the valve element (10) in its operational position in the valve plate (20).

2. The process, as set for in claim 1, characterized in that it further includes an initial step of providing the receiving recess (23) with a contour similar to and surrounding the contour of said mounting end portion (11) of the valve element (10), so that the latter is tightly disposed in said receiving recess (23).

3. The process, as set forth in claim 2, characterized in that the receiving recess (23) is provided with a contour coinciding with that of the respective valve element (10), said contour maintaining a minimum clearance from the adjacent contour of the bending median portion (12) and sealing end portion (13) of the valve element (10).

4. The process, as set in claim 1, characterized in that the part of mounting end portion (11) of the valve element (10) is retained against lateral displacement in the interior of the part of receiving recess (23) of the valve plate (20) and in a mutual seating plane of said parts, by interference of one of said parts against the other.

5. The process, as set forth in claim 1, characterized in that the orientation projection (30) is defined by at least one pin (24) projecting from the receiving recess (23) and fitted into a respective orientation recess (40) provided in the mounting end portion (11) of the valve element (10).

6. The process, as set forth in claim 6, characterized in that the valve element (10) is provided with at least one through hole (17) to receive an orientation projection (30) provided in the receiving recess (23) of the valve plate (20).

7. The process, as set forth in claim 1, characterized in that the second retaining means (50) is a viscous liquid.

8. The process, as set forth in claim 7, characterized in that the viscous liquid is an oil.

9. The process, as set forth in claim 8, characterized in that the oil is a lubricant oil.

10. The process, as set forth in claim 7, characterized in that the second retaining means (50) is an adhesive that maintains the mounting end portion (11) of the valve element (10) retained in the respective receiving recess (23) of the valve plate (20), upon mounting the valve.

11. The process, as set forth in claim 1, characterized in that the valve element (10) comprises an eccentric indexing means (18) provided in its mounting end portion (11).

12. The process, as set forth in claim 11, characterized in that the eccentric indexing means (18) is provided adjacent to an edge of the mounting end portion (11).

13. The process, as set forth in claim 1, characterized in that the valve element (10) is a suction valve, the first retaining means (8, 9) comprising a top portion of the cylinder (1) and a cylinder cover (8) seated against the valve plate (10).
